(19) United States
(12) Patent Application Publication
(10) Pub. No.: US 2024/0116053 A1
(43) Pub. Date: Apr. 11, 2024

(54) METHODS AND APPARATUS FOR THE TRAPPING AND RAPID LIGHT-DRIVEN SELECTIVE RELEASE OF DROPLETS

(71) Applicant: The Chinese University of Hong Kong, Shatin (CN)

(72) Inventors: Yi-Ping HO, Shatin (CN); Guangyao Cheng, Shenzhen (CN)

(21) Appl. No.: 18/370,820

(22) Filed: Sep. 20, 2023

Related U.S. Application Data
(60) Provisional application No. 63/413,933, filed on Oct. 6, 2022.

(51) Int. Cl. B01L 3/00

(52) U.S. Cl. CPC B01L 3/502761; B01L 2200/0668; B01L 2200/0673; B01L 2300/0663; B01L 2300/0877; B01L 2300/161; B01L 2300/168; B01L 2400/0463

(57) ABSTRACT

A method includes locating a droplet disposed in a trap in a flow channel of a microfluidic device. The droplet is stabilized by a photo-responsive fluorosurfactant (e.g., based on plasmonic nanoparticles (NPs)). The method also includes illuminating the photo-responsive fluorosurfactant on the droplet to generate sufficient heat to cause bubble formation within the trap to release the droplet from the trap.

### RELATED APPLICATIONS

This application claims priority to U.S. Provisional Patent Application No. 63/413,933, filed Oct. 6, 2022, the contents of which are hereby incorporated by reference in the entirety for all purposes.

### BACKGROUND OF THE INVENTION

This invention relates to the field of microfluidic systems. More particularly, the invention relates to light-driven selective release of droplets in microfluidic systems for improving device performances.

Droplet microfluidics has become a powerful technique for high-throughput analysis as witnessed by many applications in drug screening, directed evolution, droplet digital PCR (Polymerase Chain Reaction), and single-cell analysis. Compared with conventional microwell plate-based assays, discretizing reagents to nano- to pico-liter droplets benefits from reduced sample consumption and thus the reagent cost by orders of magnitude for an individual reaction. Automated droplet manipulation (i.e., merging, injection, sorting) and detection have simulated and even surpassed the labor-intensive sample manipulation in microwell plate-based assays. Yet, for applications such as quantitative PCR and investigation of enzymatic reactions, droplets are often deposited in traps for continuous monitoring of the reaction over an extended period.

The ability to selectively release and retrieve specific droplets is critical for downstream analysis, such as sequencing amplified DNA molecules post droplet PCR or the next round of evolution of enzymatic activity.

### BRIEF SUMMARY OF THE INVENTION

As explained further below, existing methods for droplet release in a microfluidic device suffer from various drawbacks. Embodiments of the invention address these issues by providing a platform technology for the trapping and light-driven selective release of droplets stabilized by a photo-responsive fluorosurfactant based on plasmonic nanoparticles (NPs). The technology enables droplet-based large-scale screening applications, where fast and precise retrieval of targeting droplets after extended incubation and observation are in critical need.

According to some embodiments, a microfluidic system includes a microfluidic device, which includes a flow channel with a plurality of traps and a corresponding plurality of droplets located in respective traps. The microfluidic system also includes an illumination source configured to deliver illumination to the photo-responsive fluorosurfactant on a selected droplet located in a trap to generate sufficient heat to cause bubble formation within the trap to release the droplet from the trap.

In some embodiments of the above microfluidic system, each of the droplets is a water-in-fluorocarbon oil droplet, and the photo-responsive fluorosurfactant comprises fluorinated plasmonic nanoparticles. In some embodiments, the plasmonic nanoparticles are gold-silica core-shell NPs (f-Au@SiO₂).

In some embodiments, the illumination source comprises a laser illumination for generating heat. In some embodiments, the laser operational wavelength is at 520-540 nm, or more particularly 532 nm. In some embodiments, the microfluidic system also includes a second illumination source for exciting fluorescence from the droplet. In some embodiments, the second illumination source is operated at wavelengths depending on the fluorophore inside droplets. In some embodiments, the second illumination source is a laser configured to generate illumination having a wavelength of 480-500 nm, or about 488 nm.

In some embodiments, the microfluidic system further includes a motorized stage configured to move the microfluidic device for selective release of trapped droplets.

In some embodiments, each of the plurality of traps is a hydrodynamic trap. In some embodiments, each of the plurality of traps is a floating trap.

According to some embodiments, a method includes locating a droplet disposed in a trap in a flow channel of a microfluidic device, the droplet stabilized by a photo-responsive fluorosurfactant based on plasmonic nanoparticles (NPs) and illuminating the photo-responsive fluorosurfactant on the droplet to generate sufficient heat to cause bubble formation within the trap to release the droplet from the trap.

In some embodiments of the above method, the droplet is a water-in-fluorocarbon oil droplet, and the photo-responsive fluorosurfactant comprises fluorinated plasmonic nanoparticles. In some embodiments, the plasmonic nanoparticles are gold-silica core-shell NPs (f-Au@SiO₂).

In some embodiments, the illumination source comprises a laser illumination for the generation of heat. In some embodiments, the laser illumination is operated at s a wavelength of 532 nm. In some embodiments, the microfluidic system also includes a second illumination source for exciting fluorescence from the droplet. In some embodiments, the second illumination source has wavelengths depending on the fluorophore inside droplets. In some embodiments, the second illumination source is a laser configured to generate illumination having a wavelength of about 488 nm.

According to some embodiments, a method includes performing imaging of an array of trapped droplets in a microfluidic device, each droplet stabilized by a photo-responsive fluorosurfactant based on plasmonic nanoparticles (NPs), performing image analysis of images to detect traps and droplets, and calculating coordinates of droplets to generate a path for the movement of a motorized stage on which the microfluidic device is disposed. The method also includes using laser-induced fluorescence (LIF) to determine properties of the droplets and generating a release pattern based on the properties of the droplets. The method further includes illuminating the photo-responsive fluorosurfactant on selected droplets to generate sufficient heat to cause bubble formation within the trap to release the droplet from the trap, according to the release pattern.

In some embodiments of the above method, each of the droplets is a water-in-fluorocarbon oil droplet, and the photo-responsive fluorosurfactant comprises plasmonic nanoparticles. In some embodiments, the plasmonic nanoparticles are fluorinated gold-silica core-shell NPs (f-Au@SiO₂).

In some embodiments, the illumination source comprises a laser illumination for generating heat. In some embodiments, the laser illumination has a wavelength of 532 nm. In some embodiments, the microfluidic system also includes a second illumination source for exciting fluorescence from the droplet. In some embodiments, the second illumination source has wavelengths depending on the fluorophore inside droplets. In some embodiments, the second illumination source is a laser configured to generate illumination having a wavelength of about 488 nm.

### BRIEF DESCRIPTION OF THE DRAWINGS

FIG. 1A and FIG. 1B illustrate examples of passive traps in a flow channel of a microfluidic device according to some embodiments of the present invention.

FIG. 2 illustrates bubble generation caused by photothermal response of the photo-responsive fluorosurfactant to laser illumination according to some embodiments.

FIG. 3A is a top view of a portion of a microfluidic device with a hydrodynamic trap, and FIG. 3B illustrates the release of droplet (stabilized by f-Au@SiO₂) by a light-induced bubble according to some embodiments.

FIG. 4A-FIG. 4H illustrate time-stamped images to further demonstrate the release process according to some embodiments.

FIG. 5A shows a cross-sectional view of a portion of another microfluidic device with a floating trap, and FIG. 5B illustrates the release of droplet (stabilized by f-Au@SiO₂) by a light-induced bubble according to some embodiments.

FIG. 6A-FIG. 6H illustrate time-stamped images to further demonstrate the release process according to some embodiments.

FIG. 7 is a simplified schematic diagram illustrating a fluorescence-activated droplet release platform according to some embodiments of the present invention.

FIG. 8 is a simplified flowchart illustrating a method for selective release of droplets from traps in a microfluidic device according to some embodiments.

FIG. 9 illustrates an example of experimental results of light-driven selective release of droplets according to some embodiments.

FIG. 10 illustrates another example of experimental results of light-driven selective release of droplets according to some embodiments of the present invention.

FIG. 11 is a simplified block diagram illustrating an apparatus that may be used to implement various embodiments according to the present invention.

### DETAILED DESCRIPTION OF THE INVENTION

In general, droplet traps can be broadly categorized as passive traps and active traps. The active traps utilize electric field to move the droplets. Examples of passive traps include those based on hydrodynamic resistance (termed as “hydrodynamic trap” herein) and density difference (termed as “floating trap” herein). The hydrodynamic and floating traps are widely used due to their simplicity and robustness by modulating the hydrodynamic pressure without additional force fields.

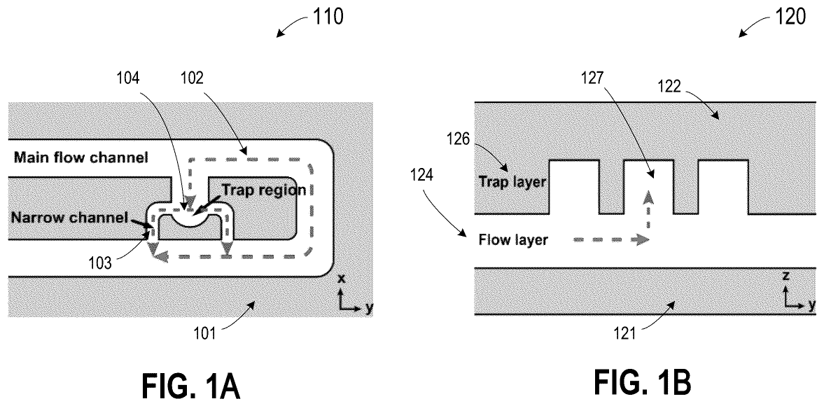

FIG. 1 illustrates examples of passive traps in a flow channel of a microfluidic device according to some embodiments of the present invention. FIG. 1A shows a portion of a microfluidic device with a hydrodynamic trap, and FIG. 1B shows a portion of another microfluidic device with a floating trap. These two types of passive traps were fabricated by soft lithography for the entrapment of droplets, given the simplicity and robustness.

FIG. 1A is a top view of a portion of a microfluidic device with a hydrodynamic trap. As shown in FIG. 1A, a microfluidic device 110 includes a main flow channel 102 and a narrow flow channel 103, also referred to as a trapping channel, formed in a substrate 101. The hydrodynamic trap functions by directing a droplet to the trap region by optimizing the hydraulic resistance between the main flow channel 102 and the trapping channel 103 connected in parallel, thereby forming a trapping region 104.

FIG. 1B shows a cross-sectional view of a portion of another microfluidic device 120 with a floating trap. As shown in FIG. 1B, microfluidic device 120 is a double-layer microfluidic chip, including a bottom substrate 121 and a top plate 122 forming a flow channel 124 consisting of a bottom flow layer and an upper trap layer. In some embodiments, the droplets are water-in-fluorocarbon oil droplets. Given the lower density of the aqueous droplet interior (water: 1 g/mL) than that of typical fluorocarbon oil (i.e., HFE-7500: 1.614 g/mL), a flowing water-in-fluorocarbon oil droplet would float upward towards the trap layer 126 and end up trapped in the trapping region 127.

The ability to selectively retrieve specific droplets is critical for downstream analysis, such as sequencing amplified DNA molecules post droplet PCR or the next round of evolution of enzymatic activity. Currently, the trapped droplets may be released by three main strategies: release by breaking the pressure balance, release by regulating the pneumatic valve, and release by light-induced bubble.

When a droplet is held in a hydrodynamic trap, the droplet is balanced between the forward hydraulic pressure and the backward Laplace pressure. Therefore, droplets may be released either forwardly or backwardly by applying pressure to alter the pressure balance of trapped droplets. The increase of hydraulic pressure, or reduced Laplace pressure by lowering the interfacial tension, is able to release the droplet forwardly.

In contrast, to release the droplet against the main flow direction, a backward flow may be applied to generate the reversed hydraulic pressure, or an external force field, such as surface acoustic waves (SAW), may be used to generate extra pressure. On the other hand, releasing droplets by regulating pneumatic valves typically requires forming a hydrodynamic trap where the droplets are trapped when the valves are closed. Droplets held in such hydrodynamic traps are released when the pneumatic valve is open. However, releasing droplets by breaking the pressure balance and regulating the pneumatic valves are constrained by complicated chip fabrication and sophisticated control, as each trap requires an independent actuation source for selective release. Controlling the actuation to release droplets in different traps becomes progressively sophisticated when the trap number scales up.

To this end, releasing droplets by light, more precisely by bubble generated under laser illumination through photothermal effect, has relieved the demand for sophisticated controllers. Typically, the release is triggered by the excitation of a non-contacting laser beam that may be positioned among individual traps as intended. Therefore, the complexity of controlled release does not expand as the trap number increases. Further, release by light-induced bubble is applicable for either the hydrodynamic or floating traps. However, in currently reported methods based on light-induced bubble release, the chip fabrication remains complicated given the need to include a photothermal material, such as aluminum patches at each trap or a single photothermal layer, thereby a wide adoption remains unfavorable. A 355 nm nanosecond pulsed laser has been employed to directly heat up the oil to exclude the requirement of photothermal material and to simplify the chip fabrication. However, an extended time of illumination, e.g., 15 min or more, is required for each release event due to the low photothermal efficiency of pure water under UV.

As can be seen from the above, current methods for droplet release are not satisfactory. Therefore, an improved technique is much desired.

Some embodiments of the present invention are directed to techniques for the trapping and light-driven selective release of droplets stabilized by a photo-responsive fluorosurfactant based on plasmonic nanoparticles (NPs). In some embodiments, the droplet is a water-in-fluorocarbon oil droplet. Due to the intense photothermal response of the photo-responsive fluorosurfactant to laser illumination, the fluorocarbon oil near the droplet interface can be superheated and vaporized quickly, e.g., at milliseconds time scale. Consequently, the generated vapor bubble pushes the droplet moving in a designated direction. This light-driven droplet movement can be applied to release droplets in passive traps selectively.

Some embodiments provide a photo-responsive fluorosurfactant based on fluorinated plasmonic nanoparticles (f-PNPs), capable of stabilizing water-in-fluorocarbon oil droplets efficiently. The fluorocarbon oil near the droplet interface may be superheated and vaporized at milliseconds time scale due to an intense photothermal response of f-PNPs under a 532 nm laser illumination. In some embodiment, techniques are provided for using light-driven droplet movement to selectively release droplets in passive traps. Compared to previously reported strategies, especially those based on light-induced bubbles, these techniques demonstrate great simplicity and faster response time.

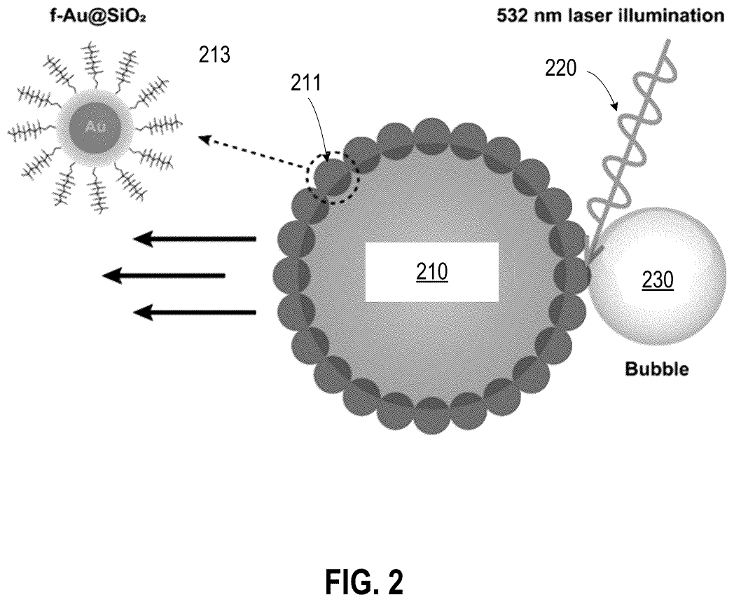

FIG. 2 illustrates bubble generation caused by photothermal response of the photo-responsive fluorosurfactant to laser illumination according to some embodiments. FIG. 2 shows a water-in-fluorocarbon oil droplet 210. Droplet 210 is an example of a Pickering emulsion, which is an emulsion (either water-in-oil or oil-in-water) that is stabilized by solid particles (for example colloidal silica) which adsorb onto the interface between the two phases. In the example of FIG. 2, droplet 210 is stabilized by a photo-responsive fluorosurfactant based on plasmonic nanoparticles (NPs). In some embodiments, the photo-responsive fluorosurfactant comprises fluorinated gold-silica core-shell NPs (f-Au@SiO₂) shown as 213 in FIG. 2.

While the stability and manipulation of droplets are part of the prerequisites to further their applications, most of the currently available surfactants serve solely as stabilizers between the interfaces of water and oil. Embodiments of the invention present a novel type of photo-responsive fluorosurfactant based on fluorinated plasmonic nanoparticles (NPs). The demonstration by fluorinated gold-silica core-shell NPs (f-Au@SiO₂) has been shown to be effective in stabilizing the water-in-fluorocarbon oil droplets. More importantly, the photothermal response enabled by the f-Au@SiO₂ has been shown to be promising for the movement of droplets as well as the alteration of interfacial stability. The unique photo-responsiveness provided by the plasmonic NPs provides the droplet microfluidics with an “active” surfactant for reconfigurable optical manipulation.

In some embodiments, fluorinated gold-silica core-shell NPs (f-Au@SiO₂) is synthesized to stabilize the aqueous droplets dispersed in fluorocarbon oil. These f-Au@SiO₂ not only stabilized the w/o (water/oil) interface, but also responded to laser irradiation, allowing localized heating around the interface. Monodispersed w/o droplets stabilized by f-Au@SiO₂ were generated by a microfluidic device and shown responsive to laser irradiation, as observed by the explosive generation of gas bubbles at the focal spot. The laser-induced bubble generation was effective in guiding the droplet toward a designated direction. The stability of droplets was also investigated under thermal perturbation through both bulk and localized heating. Notably, the localized heating enabled by the photothermal response of f-Au@O₂ at the interface has been shown to be effective in modulating the interfacial stability transiently, making the merging of droplets solely by the laser in a highly controllable manner. While an array of fluorosurfactants has been developed for the stabilization of w/o droplets, the f-Au@O₂-based surfactant presented herein represents a realization of an “active” fluorosurfactant in droplet microfluidics, enabling a new possible strategy to manipulate droplets by light.

In an embodiment, for the synthesis of the f-Au@O₂, the core AuNPs of 13±2 nm in diameter were synthesized through the Frens method. Condensation of sodium silicate (Na₂SiO₃) was then introduced to coat a 3 nm (±0.5 nm) thick silica shell onto the AuNPs. (3-Aminopropyl) trimethoxysilane (APTMS), serving as a surface primer between gold and silica for the reduction of interfacial energy, was added in an amount sufficient to form a monolayer on the core AuNPs for maintaining the uniformity of coating. Subsequently, 1H,1H,2H,2H-perfluorooctyltriethoxysilane (PFOTES) was introduced to react with the silanol groups on the surface of the silica shell, producing O₂. The extent of surface fluorophilicity is controlled in balancing the dispersity in fluorocarbon oil and stability of w/o droplets. The fluorophilicity was therefore optimized empirically based on the dispersity of f-Au@SiO₂ in fluorocarbon oil, HFE-7500, and contact angle of f-Au@SiO₂ to water. The coverage of PFOTES per unit surface area of the silica shell was optimized at around 4.6×10-22 mol/nm2. As observed by transmission electron microscopy (TEM) (FIG. 1b), the synthesized f-Au@SiO₂ exhibited an average diameter of 19±2.5 nm, characterized with a AuNP core of 13±2 nm in diameter and a 3±0.5 nm thick silica shell. This configuration was designed based on the following considerations: (1) the stability of Pickering emulsions is largely influenced by the size of the particles, (2) The localized surface plasmon resonance (LSPR) frequency of spherical metallic NPs is determined by their sizes, and (3) The heat conduction is a function of thermal conductivity.

The introduced excitation is typically maximized at the LSPR frequency of metallic NPs for the most energy absorption and the subsequent heat transformation. In other words, the LSPR frequency shall match with the frequency of excitation for an optimal photothermal effect. For the f-Au@SiO₂ synthesized in this work, the light is mostly absorbed by the AuNP core with an anticipated absorption peak near 532 nm (i.e., the designed excitation wavelength in the experiments). The thermal conductivity of gold is much higher than that of silica; therefore, a thin silica shell is preferred for an effective heat conduction from the AuNP core to the exterior. On the other hand, an adequate thickness of the silica shell is expected in practice to ensure a homogenous coating without any void.

The stabilization of water-in-oil droplets by f-Au@SiO₂ is due to its partial fluorophilicity and hydrophilicity. The f-Au@SiO₂ is expected to spontaneously attach to the interface between aqueous phase and fluorocarbon oil phase driven by the reduced interfacial energy. To demonstrate the stabilization of w/o droplets by f-Au@SiO₂, a modified flow focusing channel was used to generate monodispersed droplets. Herein, the continuous phase was revised to allow the introduction of two streams, HFE-7500 with and without f-Au@SiO₂. This configuration, different from the typical flow-focusing-based droplet microfluidics, was designed for the following reasons: (1) decouple the control of droplet size and interfacial coverage of f-Au@SiO₂, and (2) increase the local concentration of f-Au@SiO₂ for droplet stabilization. The adsorption of f-Au@SiO₂ at the interface was verified by using Rhodamine B to label the f-Au@SiO₂ through electrostatic interaction.

The photothermal response, namely, EM scattering and heating, of single f-Au@SiO₂ (core: 13 nm, shell: 3 nm) in HFE-7500 upon a plane wave illumination was studied by a simulation model established through COMSOL Multiphysics. For the configuration of synthesized f-Au@SiO₂, only the gold core was considered to be lossy under the designated illumination, given that silica absorbs negligible EM energy from the input plane wave at the studied wavelength range (400-760 nm). The calculated extinction spectrum of f-Au@SiO₂ (blue curve) peaked at 526 nm, adequately consistent with the empirically measured peak at 524 nm (red curve). A temperature drop of around 1 K was observed across the gold-silica interface as a result of contact resistance. Further temperature drop beyond the interface was due to the heat dissipation from the silica shell to the oil phase of HFE-7500, which also confirmed that a thin silica shell would be advantageous for effective heat transfer from the gold core to the medium. Transient photothermal response was then analyzed by applying the illumination at 10 ns and released at 510 ns. Both the gold core and silica shell showed a short response time against the illumination. Both surfaces were heated quickly to reach 90% of the temperature increase within 70 ns and cooled to approximately 10% of the temperature increase within approximately 70 ns.

To empirically validate the photothermal response of w/o droplets stabilized by f-Au@SiO₂, an optical setup was established. A focused 532 nm laser with a beam waist of 6 μm and power measured at around 22.6 mW was used as the excitation source. Images were simultaneously acquired by a high-speed camera at 20,000 FPS and 42 μs exposure time. 40 μm droplets stabilized by f-Au@SiO₂ were injected to a 140 μm height polydimethylsiloxane (PDMS) chamber. To ensure the photothermal effect occurring solely at the w/o interface, pure HFE-7500 was subsequently introduced to replace the f-Au@SiO₂/HFE-7500 suspension surrounding the droplets. Due to the fast and strong photothermal response from the assembled f-Au@SiO₂ at the interface, the HFE-7500 oil around the interface was superheated, and an explosive vapor bubble was observed at 18.95 ms. Note that the closely packed f-Au@SiO₂ at the w/o interface as a 3D spherical surface is anticipated to undergo a collective heating, presumably more profound than that of individual f-Au@SiO₂ discussed in the previous section, due to the superposition of multiple heat sources and coupling of plasmonic effect. The explosive expansion of the vapor bubble surface then pushed the adjacent droplet to the right. The force produced by the bubble expansion is executed onto the droplet against the Stokes drag force. The movement of droplet carried the droplet away from the laser illumination and terminated the absorption of EM energy by the interfacial f-Au@SiO₂ rapidly; therefore, the vapor bubble cooled and shrank accordingly. The movement of droplet was observed halted at around 100 μm away from the original position. Interestingly, only explosive evaporation of HFE-7500 phase rather than water was observed. The thermal conductivity and specific heat of HFE-7500 are 0.065 W/(m K) and 1128 J/(kg K) at 25° C., respectively, both are much lower than that of water, 0.6 W/(m K) and 4180 J/(kg K), respectively. Heat accumulation and temperature increase around the heat source are therefore more significant in HFE-7500 than in water, given the relatively poor heat diffusion in HFE-7500. Second, the gas solubility of HFE-7500 is higher than that of water. The aggregations of gas molecules in HFE-7500 may serve as the centers for bubble nucleation, thereby reducing the nucleation temperature and allowing an effective generation of explosive bubbles in HFE-7500. The thermal stability of f-Au@ SiO₂ under exposure to such a high temperature was validated by thermogravimetric analysis (TGA) and TEM observation. The bubble generated by photothermal response of f-Au@ SiO₂ at the w/o interface has shown to be effective in guiding the f-Au@SiO₂-stabilized droplets to a designated direction.

Given that the potential manipulation of droplets in the sorting application, the generation of explosive bubble required 18.95 msec in the current setting. The generated bubble may presumably be flushed away when the laser is turned off given a flow within the channel, consequently enabling a possible sorting frequency at around 50 Hz with a proper modulation of laser on/off and flow velocity. While the existing performance has outperformed other heat- or light-mediated droplet sorting techniques, the plasmonic-based sorting frequency may be further enhanced by optimizing the photothermal efficiency, such as tuning the wavelength of illumination to match with the LSPR frequency and increasing the power density of illumination.

In this study, plasmonic NPs f-Au@SiO₂ are synthesized as a photo-responsive fluorosurfactant. Interface of water-in-oil droplets stabilized by the f-Au@SiO₂ is shown stable and responsive to the laser irradiation. The photothermal response of f-Au@SiO₂ at the interface has enabled localized heating and subsequent manipulation of droplets. The light-mediated localized heating is effective in generating explosive bubbles around the illuminated interface. The momentum released by the bubble is able to move the droplet towards a designated direction. The localized heating is also able to destabilize the f-Au@SiO₂-covered interface by inducing desorption or lateral displacement, allowing to merge a pair of droplets in proximity. The presented f-Au@SiO₂-based surfactant represents the first realization of an active surfactant responsive to light in droplet microfluidics. The photothermal response enabled by the plasmonic NPs has also been shown to be promising for the light-mediated droplet manipulation.

Further details of fluorinated gold-silica core-shell NPs (f-Au@SiO₂) formation, its stabilization of droplet, and its photothermal response can be found in “Photo-Responsive Fluorosurfactant Enabled by Plasmonic Nanoparticles for Light-Driven Droplet Manipulation,” G. Cheng, et. Al., ACS Appl. Mater. Interfaces 2021, 13, 21914-21923, incorporated by reference in its entirety.

The fluorocarbon oil near the droplet interface may be superheated and vaporized to form a bubble 230 in a short time scale, e.g., at milliseconds time scale, due to an intense photothermal response of NPs under proper illumination. In some embodiments, a 532 nm laser illumination 220 is used.

Some embodiments of the invention describe a platform technology for the trapping and light-driven selective release of droplets stabilized by a photo-responsive fluorosurfactant based on plasmonic nanoparticles (NPs). Fluorinated gold-silica core-shell NPs (f-Au@SiO₂) are used to demonstrate the photo-responsive fluorosurfactant for droplet stabilization. Due to the intense photothermal response of f-Au@SiO₂ at 532 nm laser illumination, the fluorocarbon oil near the droplet interface can be superheated and vaporized at milliseconds time scale. Consequently, the generated vapor bubble is competent to push the droplet moving in a designated direction. This light-driven droplet movement can be applied to release droplets in passive traps selectively.

According to some embodiments, a method includes locating a droplet disposed in a trap in a flow channel of a microfluidic device, wherein the droplet stabilized by a photo-responsive fluorosurfactant based on plasmonic nanoparticles (NPs). The method also includes illuminating the photo-responsive fluorosurfactant on the droplet to generate sufficient heat to cause bubble formation within the trap to release the droplet from the trap.

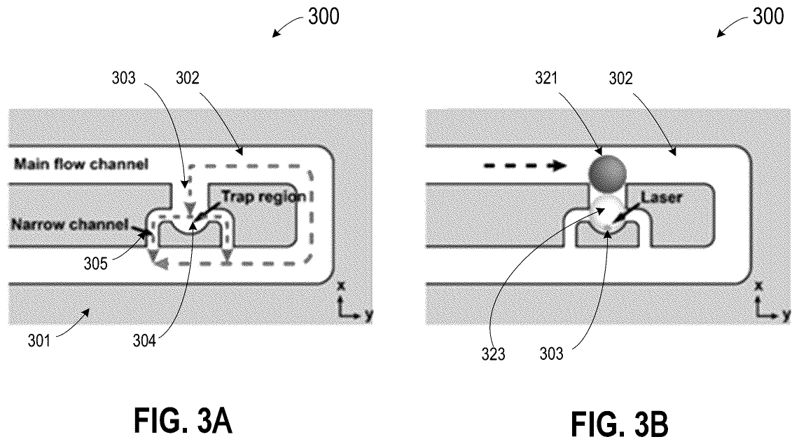

FIG. 3A is a top view of a portion of a microfluidic device with a hydrodynamic trap, and FIG. 3B illustrates the release of droplet stabilized by f-Au@SiO₂ by a light-induced bubble according to some embodiments. As shown in FIG. 3A, a microfluidic device 300 is similar to microfluidic device 110 in FIG. 1. Microfluidic device 300 includes a main flow channel 302 and a trapping channel 303, formed in a substrate 301.

A hydrodynamic trap is configured by the main flow channel 302 and the trapping channel 303 connected in parallel. The trapping channel 303 includes a trap region 304 and two narrow channels 305 connected in series. The trapping channel 303 is characterized by a hydraulic resistance is lower than that of the main flow channel 302. Therefore, the volumetric flow rate in the trapping channel is higher than that in the main flow channel. A droplet will normally follow the flow entering the trapping channel and, subsequently, the trap region, blocked by the narrow channel due to the reverse Laplace pressure. The trapping increases the hydraulic resistance in the trapping channel, preventing the following droplets from getting into the filled trap.

FIG. 3B shows the same microfluidic device 300 as that shown in FIG. 3A. A droplet 321 was initially trapped in the trap region 304. Droplet 321 is a water-in-fluorocarbon oil droplet stabilized by a photo-responsive fluorosurfactant based on plasmonic nanoparticles (NPs). Subsequently, an illumination 303 from a laser is focused on the droplet interface at the inner side of the trap region, generating a bubble 323 to guide the droplet 321 back into the main flow channel 302. In some embodiments, the photo-responsive fluorosurfactant comprises fluorinated gold-silica core-shell NPs (f-Au@SiO₂), and the illumination is provided by a 532 nm laser. The droplets 321 stabilized by f-Au@SiO₂ is characterized by a diameter of about 50 μm.

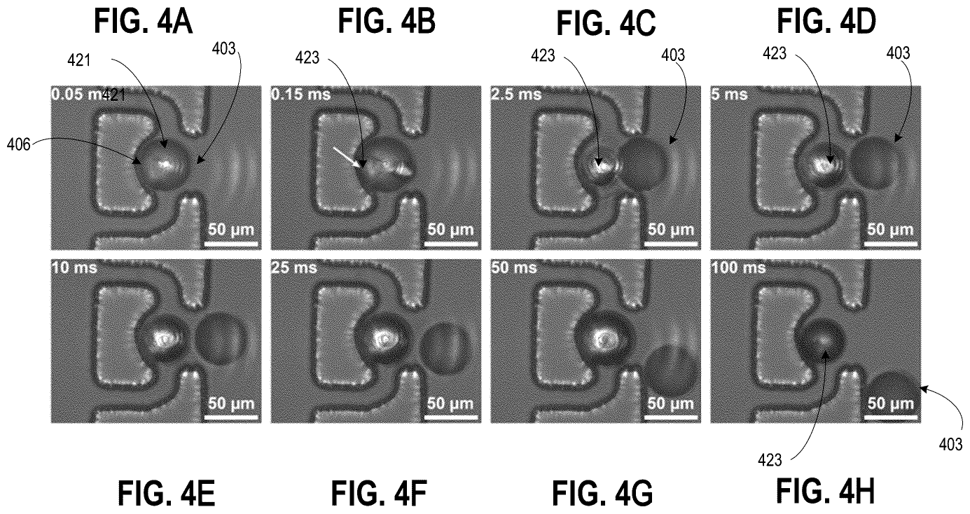

FIG. 4A-FIG. 4H illustrate time-stamped images to further demonstrate the release process according to some embodiments. FIG. 4A shows a microfluidic device with hydrodynamic traps 403 is filled with droplets 421 stabilized by f-Au@SiO₂. To simplify the drawing, only one trap and one droplet are shown in FIG. 4. In this particular example, hydrodynamic trap 403 is characterized by a height of about 55 μm, and the hydrodynamic trap region 403 is characterized by a diameter of about 60 μm.

At time=0.00 msec, a 532 nm laser is focused on the droplet interface at the inner side 406 of the trap region. FIG. 4A shows an image at time=0.05 msec.

In FIG. 4B, at time=0.15 msec, due to the intense photothermal response of f-Au@SiO₂ at the droplet interface, the temperature near the laser illumination spot at the inner side 406 of the trap region increases rapidly, vaporizing the oil phase to generate a vapor bubble 423 (also indicated by the white arrow).

In FIG. 4C to FIG. 4F, at time=2.5 msec to 25 msec, the vapor bubble 423 continuously expands in size, pushing the droplet 421 out of the trap 403.

In FIG. 4G, at time=50 msec, the droplet is thereby released from the trap, and the laser is switched off (t=50 ms).

In FIG. 4H, at time=100 msec, the droplet is further removed from the trap and ready for downstream retrieval.

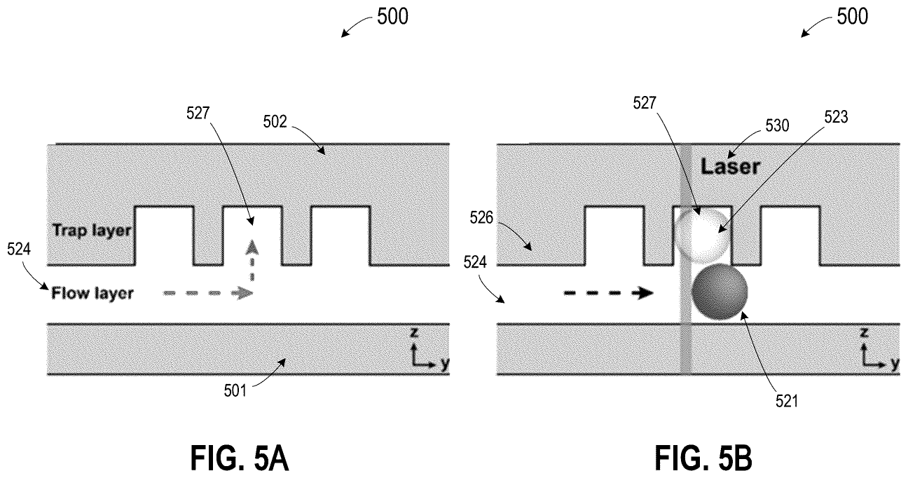

FIG. 5A shows a cross-sectional view of a portion of another microfluidic device with a floating trap, and FIG. 5B illustrates the release of droplet stabilized by f-Au@SiO₂ by a light-induced bubble according to some embodiments. As shown in FIG. 5A, a microfluidic device 500 is similar to microfluidic device 120 in FIG. 1. Microfluidic device 500 includes a double-layer microfluidic chip, including a bottom substrate 501 and a top plate 502 forming a flow channel 524 consisting of a bottom flow layer and an upper trap layer. In some embodiments, the droplets are water-in-fluorocarbon oil droplets. Given the lower density of the aqueous droplet interior (water: 1 g/mL) than that of typical fluorocarbon oil (i.e., HFE-7500: 1.614 g/mL), a flowing water-in-fluorocarbon oil droplet would float upward towards the trap layer 526 and end up trapped in the trapping region 527.

FIG. 5B shows the same microfluidic device 500 as that shown in FIG. 5A. A droplet 521 was initially trapped in the trap region 527. Droplet 521 is a water-in-fluorocarbon oil droplet stabilized by a photo-responsive fluorosurfactant based on plasmonic nanoparticles (NPs). Subsequently, an illumination from a laser 530 is focused on the droplet interface at the inner side of the trap region 527, generating a bubble 523 to guide the droplet 521 back into the main flow channel 524. In some embodiments, the photo-responsive fluorosurfactant comprises fluorinated gold-silica core-shell NPs (f-Au@SiO₂), and the illumination is provided by a 532 nm laser. The droplets 521 stabilized by f-Au@SiO₂ is characterized by a diameter of about 50 μm.

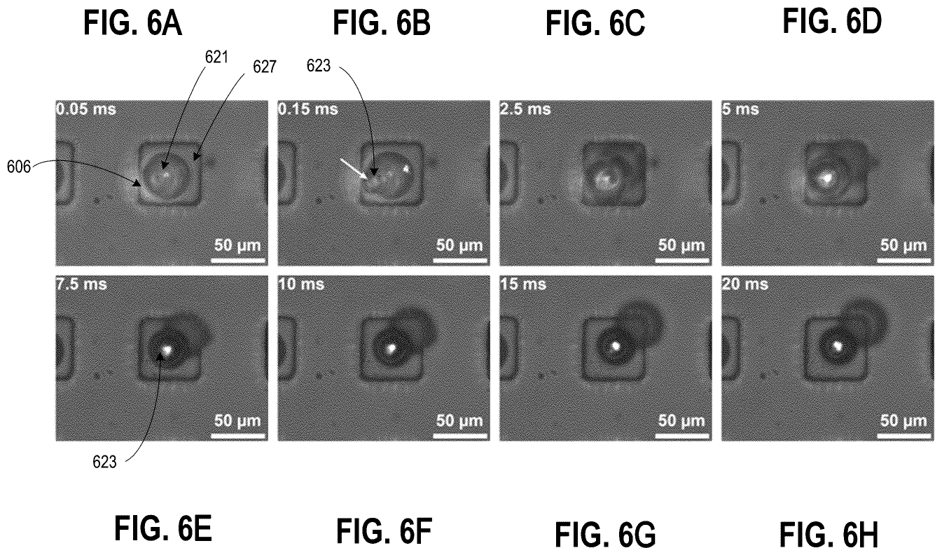

FIG. 6A-FIG. 6H illustrates time-stamped images to further demonstrate the release process according to some embodiments. FIG. 6A shows a microfluidic device with floating traps 627 is filled with droplets 621 stabilized by f-Au@SiO₂. To simplify the drawing, only one trap and one droplet are shown in FIG. 6. In this particular example, the flow layer is characterized by a height of about 65 μm, the trap layer is characterized by a height of 55 μm, the trap region is characterized by size of about 60 μm×60 μm. The droplets 621 stabilized by f-Au@SiO₂ is characterized by a diameter of about 50 μm.

In FIG. 6A, at time=0.05 msec, a 532 nm laser is used as the excitation source. The 532 nm laser is focused on the droplet interface at the inner side of the trap region.

In FIG. 6B, at time=0.15 msec, due to the intense photothermal response of f-Au@SiO₂ at the droplet interface, the temperature near the laser illumination spot 606 increases rapidly, vaporizing the oil phase to generate a vapor bubble 623 (also indicated by the white arrow).

In FIG. 6C to FIG. 6F, at time=2.5 msec to 10 msec, the vapor bubble 623 continuously expands in size, pushing the droplet 621 out of the trap 627. Due to the lateral confinement in the trap region, the expansion of the bubble pushes the droplet downward, rather than laterally, into the bottom flow layer and consequently releases the droplet.

In FIG. 6G, at time=15 msec, the droplet is thereby released from the trap, and the laser is switched off (t=15 msec).

In FIG. 6H, at time=20 msec, the droplet is further removed from the trap and ready for downstream retrieval.

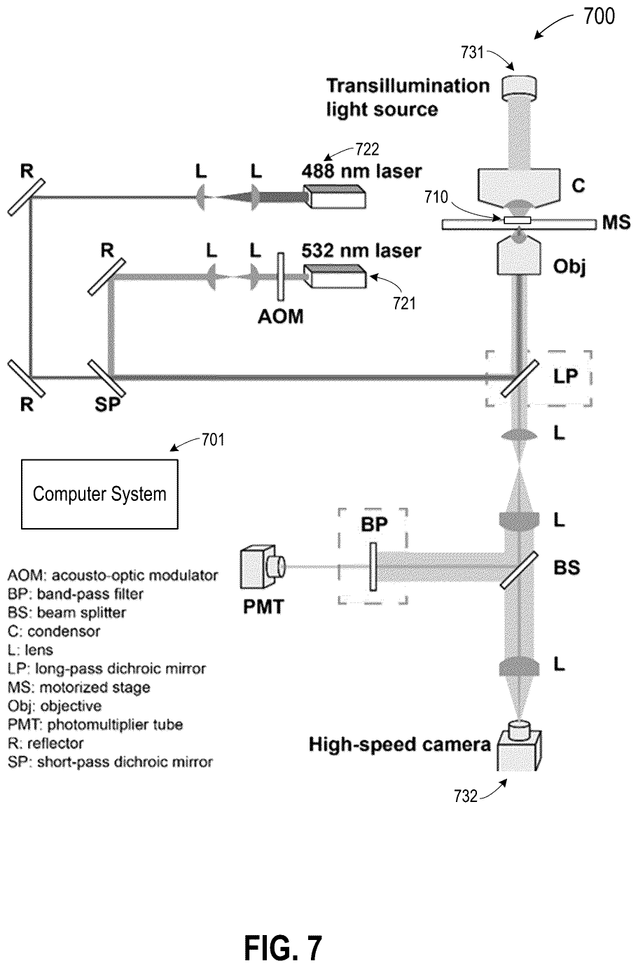

FIG. 7 is a simplified schematic diagram illustrating a fluorescence-activated droplet release platform according to some embodiments of the present invention. As shown in FIG. 7, a microfluidic system 700 includes a microfluidic device 710 disposed on a motorized stage MS. The microfluidic device 710 includes a flow channel with a plurality of trap and a corresponding plurality of droplets located in respective traps. Each droplet stabilized by a photo-responsive fluorosurfactant based on plasmonic nanoparticles (NPs). The microfluidic system 700 also includes an illumination source, in this case, a 532 nm laser 721, configured to deliver illumination to the photo-responsive fluorosurfactant on a selected droplet located in a trap to generate sufficient heat to cause bubble formation within the trap to release the droplet from the trap.

The microfluidic system 700 in FIG. 7 is an example of a fluorescence-activated droplet release (FADR) platform built to allow the selective release of fluorescently positive droplets through a dual-laser system. The release of droplets stabilized by f-Au@SiO₂ is triggered by a 532 nm laser, while a 488 nm laser (laser power: 2.4 mW, beam waist: 10 μm) is introduced as the excitation source for laser-induced fluorescence (LIF) occurring in each droplet. The emission was directed to the photomultiplier tube (PMT) and a high-speed camera through a beam splitter for the quantification of fluorescent signal and the observation, respectively. A motorized stage was included to automatically move the microfluidic device to locate the laser beams at the intended position around a droplet for LIF detection or droplet release.

In some embodiments, illumination source 721 includes is a 532 nm laser, as shown in FIG. 7. In some embodiments, microfluidic system 700 also includes a second illumination source 722 for exciting laser-induced fluorescence (LIF) from the droplet. In some embodiments, the second illumination source 722 is configured to generate illumination having a wavelength of about 488 nm.

The motorized stage MS configured to move the microfluidic device for selective release of trapped droplets.

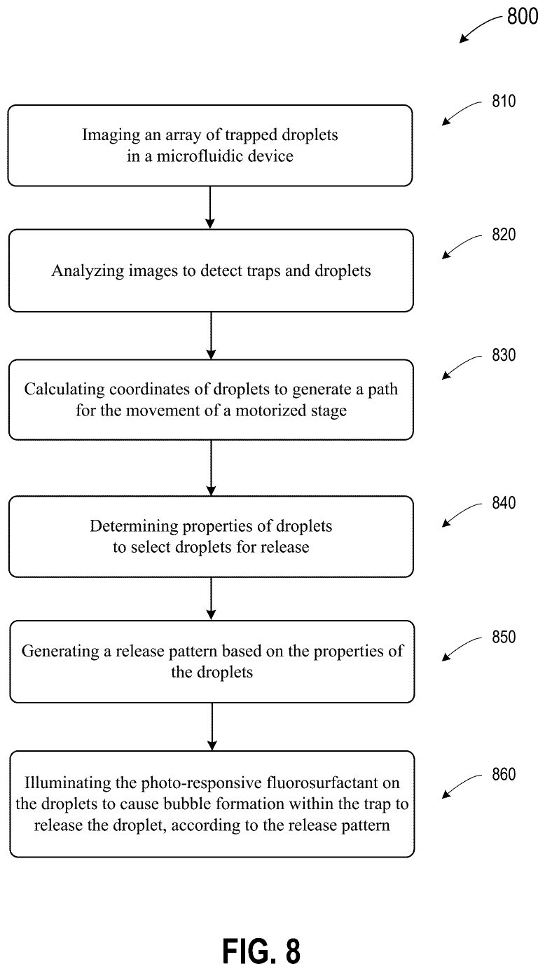

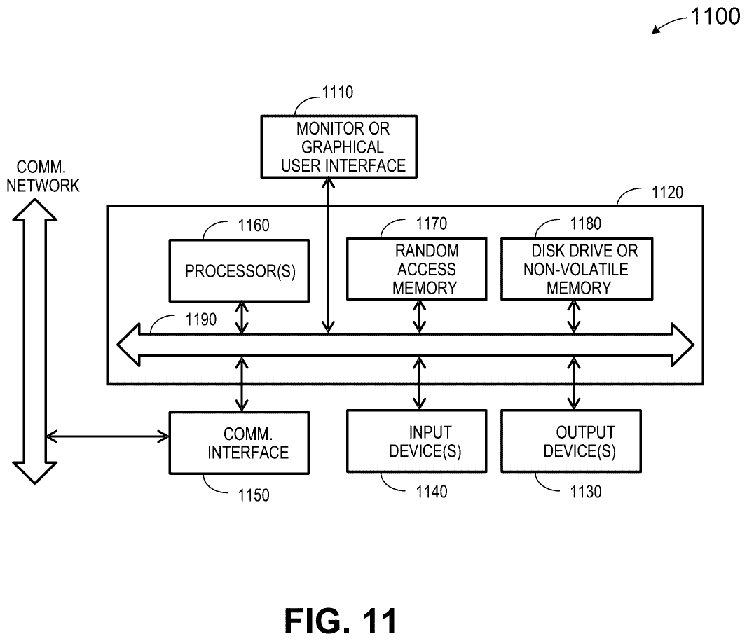

In some embodiments, microfluidic system 700 also includes an acousto-optic modulator (AOM), a band-pass filter (BP), a beam splitter (BS), a condenser (C), lenses (L), a long-pass dichroic mirror (LP), an objective lens (Obj), a photomultiplier (PMT), reflectors (R), and a short-pass dichroic mirror. In some embodiments, microfluidic system 700 also includes a transillumination light source 731 and a high-speed camera 732. In some embodiments, system 700 also includes a computer system 701 that is coupled to the various components and controls the operation of system 701 as described below with reference to the flowchart in FIG. 8. An example of a computer system that can be used as computer system 701 is described below with reference to FIG. 11.

FIG. 8 is a simplified flowchart illustrating a method for selective release of droplets from traps in a microfluidic device according to some embodiments. Method 800 in FIG. 8 can be summarized below and further explained with reference to the microfluidic system 700 illustrated in FIG. 7.
At 810—Imaging of an array of trapped droplets in a microfluidic device, each droplet stabilized by a photo-responsive fluorosurfactant based on plasmonic nanoparticles (NPs);
At 820—Performing image analysis of the images to detect traps and droplets;
At 830—Calculating coordinates of droplets to generate a path for the movement of a motorized stage on which the microfluidic device is disposed;
At 840—Determining properties of droplets to select droplets for release;
At 850—Generating a release pattern based on the properties of the droplets; and
At 860—illuminating the photo-responsive fluorosurfactant on the droplets to generate sufficient heat to cause bubble formation within the trap to release the droplet from the trap, according to the release pattern.

In various embodiments, method 800 can be controlled by computer system 701. An example of a computer system that can be used as computer system 701 is described below with reference to FIG. 11.

The method 800 includes, at 810, performing imaging of an array of trapped droplets in a microfluidic device, each droplet stabilized by a photo-responsive fluorosurfactant based on plasmonic nanoparticles (NPs). In some embodiments, the imaging can be microscopic bright-field imaging. As shown in FIG. 7, microfluidic device 710 is disposed on a motorized stage MS. Microfluidic device 710 can include flow channels and traps, such as hydrodynamic traps and/or floating traps. Examples of microfluidic device 710 are described above in connection with FIGS. 3-6. As the droplets flow through the flow channel, some of the droplets are trapped in the traps. In some embodiments, each of the droplets is a water-in-fluorocarbon oil droplet. The droplets are stabilized by a photo-responsive fluorosurfactant based on plasmonic nanoparticles (NPs). For example, the photo-responsive fluorosurfactant includes fluorinated gold-silica core-shell NPs (f-Au@SiO₂), as described above in connection to FIG. 2. The imaging of the traps and droplets can be carried out using the optical components described in FIG. 7, including high-speed camera 732, under the control of computer system 701.

The method 800 includes, at 820, performing image analysis of the images to detect traps and droplets. The image analysis can include trap and droplet location detection. For example, the image analysis can be performed using the computer system 701.

At 830, the method 800 includes calculating coordinates of droplets to generate a path for the movement of the motorized stage on which the microfluidic device is disposed. Referring to FIG. 7, computer system 701 is used to calculate the coordinates of the droplets for the movement of the motorized stage MS.

At 840, the method determines the properties of the droplets to select droplets for release. In some embodiments, laser-induced fluorescence (LIF) of the droplets with a 488 nm laser is used to determine properties of the droplets. In this case, the motorized stage MS moves to excite laser-induced fluorescence (LIF) of droplets with the 488 nm laser 722 one by one. In some cases, the LIF is used to determine fluorescently positive and negative droplets and selecting the droplets through thresholding and binarization. Computer system 701 can be used in controlling the LID operation and the thresholding and binarization of the properties.

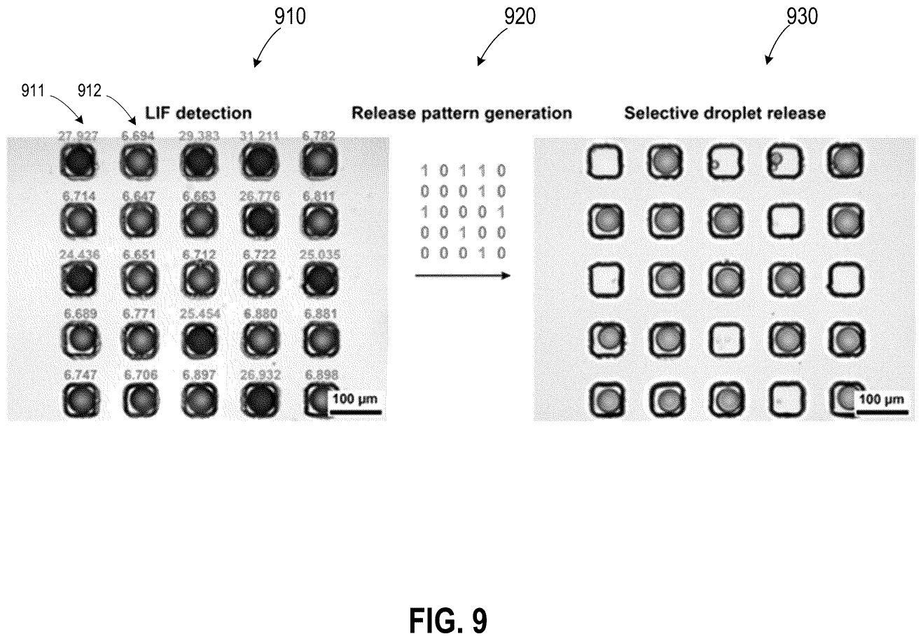

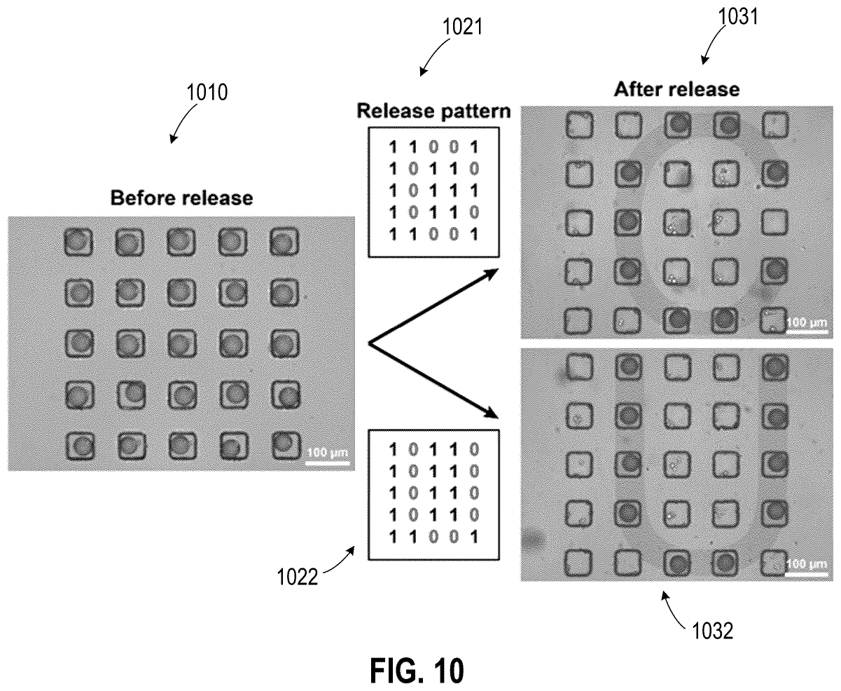

The method 800 includes, at 850, generating a release pattern based on the properties of the droplets. The release pattern is uses to determine which trapped droplets are released using the bubble generation by laser excitation of the photo-responsive fluorosurfactant on the droplets. Examples of release patterns are described below with reference to FIGS. 9 and 10.

At 860, a laser, e.g., a 532 nm laser 721, is used to illuminate the photo-responsive fluorosurfactant on the droplet to generate sufficient heat to cause bubble formation within the trap to release the selected droplet from the trap, according to the release pattern. The release operation is described above in detail in connection with FIGS. 2-7. Again, this release operation according to the release pattern can be carried out with movement of the motorized stage MS under controlled with computer system 701. The results of the operation can be recorded.

In summary, the flowchart in FIG. 8 describes an example workflow of fluorescence-activated droplet release (FADR) platform. An array of trapped droplets stabilized by f-Au@SiO₂ is bright-field imaged, through which the traps and droplets are detected by image analysis. The coordinates of droplets are then calculated to generate a path for the movement of the motorized stage. The motorized stage moves to excite the LIF of droplets with the 488 nm laser one by one, which is then used to determine fluorescently positive and negative droplets through thresholding. Finally, a binarized release pattern is generated and fed back to the motorized stage for selective droplet release by the 532 nm laser illumination.

FIG. 9 illustrates an example of experimental results of light-driven selective release of droplets according to some embodiments. To demonstrate the FADR process, fluorescently positive and negative droplets stabilized by f-Au@SiO₂ are generated separately. The two types of droplets are then mixed and randomly trapped in a 5×5 floating trap array 910, as shown in FIG. 9. The aqueous phase for fluorescently positive droplets consisted of fluorescein isothiocyanate (FITC, 0.01 mg/mL) and Trypan blue (0.2%), allowing the droplets to show green fluorescence under blue light excitation and dark under bright-field imaging. On the other hand, fluorescently negative droplets contain merely DI water. The floating trap array filled with droplets is imaged, and the droplets are coordinated by image analysis.

Subsequently, the long-pass dichroic mirror (DM) is switched to allow the 488 nm laser illuminating the droplets for LIF excitation. In this case, all droplets are moved underneath the laser focus sequentially to acquire LIF intensities detected by the PMT. As shown in 910 in FIG. 9, the detected LIF intensity is registered and labeled for each droplet. The dark droplets show higher LIF intensities than the bright droplets. For example, reference numeral 911 shows a relative intensity of 27.927 for a dark droplet, and reference numeral 912 shows a relative intensity of 6.694 for a bright droplet. This result is consistent with the anticipated droplet properties for the two groups. A threshold of LIF intensity is then determined for the generation of the release pattern, where the LIF intensity above and below the threshold is binarized to 1 and 0, respectively. Here, 1 and 0 are referred to an event of released and retained droplets, respectively. A binary number array, release pattern 920, with the same shape as the floating trap array (5×5 here) is generated to guide the selective droplet release.

The long-pass DM (dichroic mirror) is then switched to allow the passing of the 532 nm laser for droplet release. With the defined release pattern 920 from LIF intensity, fluorescently positive droplets are released one by one. Droplets located closer to the upstream of flow are released first, followed by those located towards the downstream to prevent the released droplets from re-entering empty traps farther downstream. Laser illumination for each release event is typically set at 5 msec, while a laser pulse of 0.05 msec is observed possible for a satisfyingly successful rate.

The generated vapor bubbles are either washed out by the flow or dissipated after the laser is switched off without interfering with subsequent release events. Fluorescently negative droplets are unaltered in the floating trap array, as shown in 930 in FIG. 9. On the other hand, selective release of fluorescently negative droplets may be achieved by simply reversing the polarity of binary number array generated from the detected LIF intensity. The fully automated workflow controlled by a custom Labview and Python program is able to complete the FADR within seconds. After the selective release and retrieval downstream, all remained droplets may also be released and washed out for another round of the trap-and-release process. Therefore, the traps are reusable without any functional damage.

FIG. 10 illustrates another example of experimental results of light-driven selective release of droplets according to some embodiments of the present invention. Similar to FIG. 9, FIG. 10 shows a 5×5 floating trap array 1010, with all traps occupied by droplets stabilized by f-Au@SiO₂. A first droplet release operation is carried out with a first release pattern 1021, in which “1” marks droplets to be released and “0” marks droplets not to be released. After the release, diagram 1031 shows droplets that remain in the 5×5 floating trap array match the release pattern. A second droplet release operation is carried out with a second release pattern 1022, in which “1” marks droplets to be released and “0” marks droplets not to be released. After the release, diagram 1032 shows droplets that remain in the 5×5 floating trap array match the release pattern.

As described above, photo-responsive fluorosurfactant based on plasmonic NPs has enabled the selective release of droplets trapped in hydrodynamic traps and floating traps. The intense photothermal response of plasmonic NPs at the droplet interface enables the vaporization of the oil phase under laser illumination, generating a bubble to displace the trapped droplets for selective release. The release event can also be triggered by fluorescence signal, the most commonly used staining in biochemical reactions. Among the reported release methods by light-induced bubble, the presented release platform herein demonstrates the salient features of simple chip fabrication, low laser power, short response time, facile scale-up ability, and reusability of the microfluidic traps. Taken together, the automated trap-and-release platform enabled by fluorinated plasmonic NPs can be used for the droplet-based large-scale screening applications, where fast and precise retrieval of targeting droplets after extended incubation and observation are in critical need.

FIG. 11 is a simplified block diagram illustrating an apparatus that may be used to implement various embodiments according to the present invention. FIG. 11 is merely illustrative of an embodiment incorporating the present disclosure and does not limit the scope of the disclosure as recited in the claims. One of ordinary skill in the art would recognize other variations, modifications, and alternatives. In one embodiment, computer system 1100 typically includes a monitor 1110, a computer 1120, user output devices 1130, user input devices 1140, communications interface 1150, and the like.

FIG. 11 is representative of a computer system capable of embodying the present disclosure. For example, computer system 701 in FIG. 7 can be implemented using a system similar to system 1100 depicted in FIG. 11. Various operations of system 700 and method 800 described above using computer system 701 can be performed using a system similar to system 1100 depicted in FIG. 11.

As shown in FIG. 11, computer 1120 may include a processor(s) 1160 that communicates with a number of peripheral devices via a bus subsystem 1190. These peripheral devices may include user output devices 1130, user input devices 1140, communications interface 1150, and a storage subsystem, such as random access memory (RAM) 1170 and disk drive 1180.

User input devices 1140 can include all possible types of devices and mechanisms for inputting information to computer 1120. These may include a keyboard, a keypad, a touch screen incorporated into the display, audio input devices such as voice recognition systems, microphones, and other types of input devices. In various embodiments, user input devices 1140 are typically embodied as a computer mouse, a trackball, a track pad, a joystick, wireless remote, drawing tablet, voice command system, eye tracking system, and the like. User input devices 1140 typically allow a user to select objects, icons, text, and the like that appear on the monitor 1110 via a command such as a click of a button or the like.

User output devices 1130 include all possible types of devices and mechanisms for outputting information from computer 1120. These may include a display (e.g., monitor 1110), non-visual displays such as audio output devices, etc.

Communications interface 1150 provides an interface to other communication networks and devices. Communications interface 1150 may serve as an interface for receiving data from and transmitting data to other systems. Embodiments of communications interface 1150 typically include an Ethernet card, a modem (telephone, satellite, cable, ISDN), (asynchronous) digital subscriber line (DSL) unit, FireWire interface, USB interface, and the like. For example, communications interface 1150 may be coupled to a computer network, to a FireWire bus, or the like. In other embodiments, communications interfaces 1150 may be physically integrated on the motherboard of computer 1120, and may be a software program, such as soft DSL, or the like.

In various embodiments, computer system 1100 may also include software that enables communications over a network such as the HTTP, TCP/IP, RTP/RTSP protocols, and the like. In alternative embodiments of the present disclosure, other communications software and transfer protocols may also be used, for example IPX, UDP or the like. In some embodiments, computer 1120 includes one or more Xeon microprocessors from Intel as processor(s) 1160. Further, in one embodiment, computer 1120 includes a UNIX-based operating system. Processor(s) 1160 can also include special-purpose processors such as a digital signal processor (DSP), a reduced instruction set computer (RISC), etc.

RAM 1170 and disk drive 1180 are examples of tangible storage media configured to store data such as embodiments of the present disclosure, including executable computer code, human readable code, or the like. Other types of tangible storage media include floppy disks, removable hard disks, optical storage media such as CD-ROMS, DVDs and bar codes, semiconductor memories such as flash memories, read-only memories (ROMS), battery-backed volatile memories, networked storage devices, and the like. RAM 1170 and disk drive 1180 may be configured to store the basic programming and data constructs that provide the functionality of the present disclosure.

Software code modules and instructions that provide the functionality of the present disclosure may be stored in RAM 1170 and disk drive 1180. These software modules may be executed by processor(s) 1160. RAM 1170 and disk drive 1180 may also provide a repository for storing data used in accordance with the present disclosure.

RAM 1170 and disk drive 1180 may include a number of memories including a main random access memory (RAM) for storage of instructions and data during program execution and a read-only memory (ROM) in which fixed non-transitory instructions are stored. RAM 1170 and disk drive 1180 may include a file storage subsystem providing persistent (non-volatile) storage for program and data files. RAM 1170 and disk drive 1180 may also include removable storage systems, such as removable flash memory.

Bus subsystem 1190 provides a mechanism for letting the various components and subsystems of computer 1120 communicate with each other as intended. Although bus subsystem 1190 is shown schematically as a single bus, alternative embodiments of the bus subsystem may utilize multiple busses.

FIG. 11 is representative of a computer system capable of embodying the present disclosure. It will be readily apparent to one of ordinary skill in the art that many other hardware and software configurations are suitable for use with the present disclosure. For example, the computer may be a desktop, portable, rack-mounted or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc.; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

Various embodiments of the present disclosure can be implemented in the form of logic in software or hardware or a combination of both. The logic may be stored in a computer-readable or machine-readable non-transitory storage medium as a set of instructions adapted to direct a processor of a computer system to perform a set of steps disclosed in embodiments of the present disclosure. The logic may form part of a computer program product adapted to direct an information-processing device to perform a set of steps disclosed in embodiments of the present disclosure. Based on the disclosure and teachings provided herein, a person of ordinary skill in the art will appreciate other ways and/or methods to implement the present disclosure.

The data structures and code described herein may be partially or fully stored on a computer-readable storage medium and/or a hardware module and/or hardware apparatus. A computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described herein include, but are not limited to, application-specific integrated circuits (ASICs), field-programmable gate arrays (FPGAs), dedicated or shared processors, and/or other hardware modules or apparatuses now known or later developed.

The methods and processes described herein may be partially or fully embodied as code and/or data stored in a computer-readable storage medium or device, so that when a computer system reads and executes the code and/or data, the computer system performs the associated methods and processes. The methods and processes may also be partially or fully embodied in hardware modules or apparatuses, so that, when the hardware modules or apparatuses are activated, they perform the associated methods and processes. The methods and processes disclosed herein may be embodied using a combination of code, data, and hardware modules or apparatuses.

Certain embodiments have been described. However, various modifications to these embodiments are possible, and the principles presented herein may be applied to other embodiments as well. In addition, the various components and/or method steps/blocks may be implemented in arrangements other than those specifically disclosed without departing from the scope of the claims. Other embodiments and modifications will occur readily to those of ordinary skill in the art in view of these teachings. Therefore, the following claims are intended to cover all such embodiments and modifications when viewed in conjunction with the above specification and accompanying drawings.

What is claimed is:

1. A microfluidic system, comprising:
a microfluidic device, including;
a flow channel with a plurality of traps; and
a corresponding plurality of droplets located in respective ones of the plurality of traps, each droplet stabilized by a photo-responsive fluorosurfactant based on plasmonic nanoparticles (NPs); and
an illumination source configured to deliver illumination to the photo-responsive fluorosurfactant on a selected droplet located in a trap to generate sufficient heat to cause bubble formation within the trap to release the droplet from the trap.

2. The system of claim 1, wherein each of the droplets is a water-in-fluorocarbon oil droplet.

3. The system of claim 2, wherein the photo-responsive fluorosurfactant comprises fluorinated gold-silica core-shell NPs (f-Au@SiO₂).

4. The system of claim 1, wherein the illumination source comprises a 520-540 nm laser illumination.

5. The system of claim 1, further comprising a second illumination source for exciting laser-induced fluorescence (LIF) from the droplet.

6. The system of claim 5, wherein the second illumination source is configured to generate illumination having a wavelength of 480-500 nm.

7. The system of claim 1, further comprising a motorized stage configured to move the microfluidic device for selective release of trapped droplets.

8. The system of claim 1, wherein each of the plurality of traps is a hydrodynamic trap.

9. The system of claim 1, wherein each of the plurality of traps is a floating trap.

10. A method, comprising:
locating a droplet disposed in a trap in a flow channel of a microfluidic device, the droplet stabilized by a photo-responsive fluorosurfactant based on plasmonic nanoparticles (NPs); and
illuminating the photo-responsive fluorosurfactant on the droplet to generate sufficient heat to cause bubble formation within the trap to release the droplet from the trap.

11. The method of claim 10, wherein the droplet is a water-in-fluorocarbon oil droplet.

12. The method of claim 11, wherein the photo-responsive fluorosurfactant comprises fluorinated gold-silica core-shell NPs (f-Au@SiO₂).

13. The method of claim 10, wherein the illuminating comprises delivering illumination having a wavelength of 520-540 nm.

14. The method of claim 10, further comprising selecting a target droplet for release by laser-induced fluorescence (LIF) from the droplet.

15. The method of claim 14, further comprising generating laser-induced fluorescence (LIF) using illumination having a wavelength of 480-500 nm.

16. A method, comprising:
performing imaging of an array of trapped droplets in a microfluidic device, each droplet stabilized by a photo-responsive fluorosurfactant based on plasmonic nanoparticles (NPs);
performing image analysis of images to detect traps and droplets;
calculating coordinates of droplets to generate a path for the movement of a motorized stage on which the microfluidic device is disposed;
determining properties of the droplets;
generating a release pattern based on the properties of the droplets; and
illuminating the photo-responsive fluorosurfactant on selected droplets to generate sufficient heat to cause bubble formation within the trap to release the droplet from the trap, according to the release pattern.

17. The method of claim 16, wherein the droplet is a water-in-fluorocarbon oil droplet.

18. The method of claim 17, wherein the photo-responsive fluorosurfactant comprises fluorinated gold-silica core-shell NPs (f-Au@SiO₂).

19. The method of claim 16, wherein the illuminating comprises delivering illumination having a wavelength of about 480-500 nm.

20. The method of claim 16, further comprising generating laser-induced fluorescence (LIF) using illumination having a wavelength of 480-500 nm.
